(19) United States
(12) Patent Application Publication
(10) Pub. No.: US 2009/0108731 A1
(43) Pub. Date: Apr. 30, 2009

(54) ELECTRODE FOR COLD-CATHODE FLUORESCENT LAMP

(75) Inventors: Koji Nitta, Osaka (JP); Shinji Inazawa, Osaka (JP); Akihisa Hosoe, Osaka (JP); Kazuo Yamazaki, Osaka (JP); Hisashi Tokuda, Osaka (JP)

Correspondence Address: OSHA LIANG L.L.P., TWO HOUSTON CENTER, 909 FANNIN, SUITE 3500, HOUSTON, TX, 77010, US

(73) Assignees: SUMITOMO ELECTRIC INDUSTRIES, LTD., Osaka (JP); SUMIDEN FINE CONDUCTORS, CO., LTD., Osaka (JP)

(21) Appl. No.: 11/996,736

(22) PCT Filed: Mar. 15, 2007
(86) PCT No.: PCT/JP2007/055282

§ 371 Date: Jan. 24, 2008

(30) Foreign Application Priority Data
Aug. 4, 2006 (JP) 2006-213947
Nov. 29, 2006 (JP) 2006-322637

(51) Int. Cl. H01J 1/30

(52) U.S. Cl. 313/491

(57) ABSTRACT

A cold-cathode fluorescent lamp having high brightness with long life and an electrode for this lamp are offered. At least one part of the electrode surface is formed by using one material selected from the group consisting of rhodium, palladium, and alloys of these. For example, a surface layer made of the foregoing material is formed on a base. To increase the bonding strength between the surface layer and the base, a bonding layer made of gold or gold alloy is formed on the base. Because a metal such as rhodium is resistant to alloying with mercury and has a high melting point, a cold-cathode fluorescent lamp provided with an electrode made of the foregoing metal can suppress not only the consumption of the mercury due to the formation of an amalgam but also the reduction in brightness due to insufficient discharging. Furthermore, because the lamp can suppress the consumption of the mercury and electrode, the lamp has long life.

### TECHNICAL FIELD

The present invention relates to an electrode to be used for a cold-cathode fluorescent lamp and a cold-cathode fluorescent lamp provided with the foregoing electrode. In particular, the present invention relates to an electrode suitable for a cold-cathode fluorescent lamp having high brightness and long life.

### BACKGROUND ART

Cold-cathode fluorescent lamps have been used as various light sources such as a light source for illuminating documents in a copying machine, an image scanner or the like and a light source as a backlight for a liquid-crystal monitor of a personal computer or for a liquid-crystal display of a liquid-crystal television or the like. A cold-cathode fluorescent lamp is typically provided with a glass tube that has a layer of a fluorescent substance on its inner surface, that has sealed-in rare gas and mercury, and that has a pair of electrodes in it. A lead wire is welded to the end portion of each of the electrodes to apply voltage through it. The lead wire is typically classified into an inner lead wire that is fixed in the glass tube and an outer lead wire that is placed outside the tube. The fluorescent lamp emits light through the following process: (a) a high voltage is applied across the two electrodes, (b) electrons in the glass tube are forced to collide with the electrode, (c) the electrode emits electrons (to form electric discharge), (d) the interaction between the discharge and the mercury in the tube radiates ultraviolet light, and (e) the ultraviolet light stimulates the fluorescent substance to emit light.

A representative example of the above-described electrode is made of pure nickel (Ni). In addition, Patent literature 1 has disclosed a coated electrode in which an electrode made of zirconium (Zr) is provided with a Zr carbide layer on its surface to suppress the formation of an amalgam.

Patent literature 1: the published Japanese patent application 2005-85472.

### DISCLOSURE OF THE INVENTION

### Problem to be Solved by the Invention

In recent years, the market has strongly required to get a cold-cathode fluorescent lamp having high brightness and long life. Consequently, an electrode that satisfies the foregoing requirement has been needed.

To achieve high brightness, it is conceivable to increase the current to be fed to the electrode. However, if the current is increased, the consumption of the electrode is sped up due to sputtering and the like, thereby shortening the life. In addition, in recent years, in view of the circumstances of the energy-saving effort, there has been a tendency of evading the increase in the current. Therefore, it is necessary to improve the performance of the electrode itself.

The present invention has been made in view of the above-described circumstances. A main object of the present invention is to offer an electrode suitable for a cold-cathode fluorescent lamp having long life and high brightness. Another object of the present invention is to offer a cold-cathode fluorescent lamp having high brightness and long life.

### Means to Solve the Problem

To realize a cold-cathode fluorescent lamp having high brightness and long life, the present inventors have studied the property needed for the electrode industriously by focusing attention particularly on the following points: (a) the electrode is to be resistant to alloying with mercury (resistant to forming an amalgam) and (b) the electrode is to have a high melting point.

In a cold-cathode fluorescent lamp, a phenomenon known as “sputtering” occurs through the following process: mercury ions produced by the discharge between the electrodes collide with the electrodes to scatter the electrode substance in the glass tube and deposit it on the inner surface of the glass tube. When the electrode substance tends to form an amalgam, the deposited matter (the sputtering layer) incorporates the mercury. As a result, the ultraviolet light cannot be emitted sufficiently, thereby decreasing the brightness. In addition, because the sputtering layer consumes the mercury, the life of the fluorescent lamp is shortened as a result. Consequently, when the consumption of the mercury by the sputtering layer is reduced, a fluorescent lamp can have high brightness and long life.

On the other hand, the energy when the electron in the glass tube collides with the electrode is as extremely high as 10⁷ eV or so. Consequently, an electrode having a low melting point (or a low liquidus temperature) will melt at the atomic level when collided by electrons. After the melting, it liquefies or vaporizes, rendering the discharging insufficient. As a result, the brightness of the fluorescent lamp is decreased. Furthermore, the consumption of the electrode due to the above-described liquefaction and vaporization shortens the life of the fluorescent lamp. Therefore, the reduction in the consumption of the electrode due to the collision of electrons can cause a fluorescent lamp to have high brightness and long life.

As the material that satisfies the properties described in (a) and (b) above, it has been found that it is desirable to use rhodium, palladium, and alloys of these, such as a rhodium alloy and a palladium alloy. Based on this finding, an electrode of the present invention is formed by using these metals. More specifically, an electrode of the present invention for a cold-cathode fluorescent lamp is structured such that at least one part of the electrode surface is formed by using one material selected from a first group consisting of rhodium, palladium, and alloys of these.

An electrode of the present invention is structured such that at least one part of the electrode surface is formed by using a metal, such as rhodium, palladium, or alloys of these, which are resistant to forming an amalgam and which have a high melting point. This structure effectively reduces not only the consumption of the mercury due to the sputtering layer but also the consumption of the electrode due to the melting at the time of the collision of electrons. Consequently, the use of an electrode of the present invention can realize a cold-cathode fluorescent lamp having high brightness and long life. The present invention is explained below in further detail.

As described above, an electrode of the present invention is structured such that at least one part of the electrode surface is formed by using one material (hereinafter referred to as a first material) selected from a first group consisting of rhodium (Rh), palladium (Pd), and alloys of these, more specifically, a rhodium alloy (an Rh alloy), a palladium alloy (a Pd alloy), and a rhodium-palladium alloy (an Rh—Pd alloy). The types of Rh alloy include an Rh—Co alloy and an Rh—Ni alloy, for example. The types of Pd alloy include a Pd—Co alloy and a Pd—Ni alloy, for example. A Pd alloy having a commonly known composition may be used. The types of Rh—Pd alloy include an Rh—Pd two-phase alloy, an Rh—Pd—Co alloy, and an Rh—Pd—Ni alloy, for example. In the case of the two-phase alloy, one of the following two types of alloy may be used: one is an alloy that contains Rh or Pd as the main constituent and the other is an alloy that contains the same amounts of the two elements.

As described above, the first material not only is resistant to alloying with mercury and has a high melting point but also has a low temperature coefficient of resistance. When the electrode has a high electric resistance, a part of the supplied current is used to generate Joule heat, reducing the energy efficiency. Consequently, when the electrode has a low temperature coefficient of resistance, the electrode is resistant to increasing its electric resistance due to the heat generation at the atomic level at the time of the collision of electrons. Thus, the deterioration of the energy efficiency can be reduced. As a result, a cold-cathode fluorescent lamp provided with the electrode using the first material has a high energy efficiency and therefore materializes energy saving.

An electrode of the present invention is required only to have a structure in which at least one part of the electrode surface is formed by using the first material. For example, the entire electrode may be formed by using the first material. Alternatively, the electrode may have a structure in which the surface portion is formed by using the first material and the inner portion is formed by using a material different from the first material. When the entire electrode is formed by using the first material, which is the former case, the formation of the amalgam has the least possibility. Consequently, the consumption of the electrode due to the collision of electrons can be reduced to a minimum. As a result, the use of the electrode can produce a cold-cathode fluorescent lamp having extremely high brightness and long life.

When the electrode is formed by using different materials to form the surface portion and inner portion, which is the latter case, the electrode of the present invention is specified, for example, to comprise a base and a covering layer that covers at least one part of the surface of the base, with the surface portion of the covering layer being formed by using the first material. The present inventors have studied about the covering layer to find that when a layer made of the first material is formed directly on the base, the residual stress at the time of the layer formation will separate the first-material layer from the base. In particular, because the first-material layer has a relatively high hardness, it easily separates from the base. In other words, the first-material layer has a low bonding property to the base. To solve this problem, a layer that can relieve the stress produced at the time of the formation of the first-material layer and that has an excellent bonding property to the base is provided directly on the base. In other words, this layer is used to bond the first-material layer to the base. As a result, the covering layer comprises (a) a bonding layer provided directly on the base and (b) a surface layer provided on the bonding layer. The surface layer is formed by using the first material.

The surface layer made of the first material can be formed by the electroplating method or the sputtering method. In particular, even when the base has a complicated shape, such as the shape of a cup, the electroplating method can form a uniform surface layer on its surface, particularly the inner surface of the cup. Therefore, it is desirable to use this method. Furthermore, the electroplating method has an excellent mass-productivity.

As its thickness increases, the surface layer can increase its contribution to the increase in the brightness and life of the cold-cathode fluorescent lamp. Consequently, no upper limit is specified in the thickness of the surface layer. However, when the surface layer is formed by the plating method, it is considered that the production limit is 10 μm or so. On the other hand, if the surface layer is excessively thin, particularly less than 0.05 μm, the effect of increasing the brightness and life of the cold-cathode fluorescent lamp cannot be expected. Therefore, it is desirable that the surface layer have a thickness of 0.05 to 10 μm, more desirably 0.2 to 5 μm, in particular.

The present inventors have found that as the material that satisfies the property required for the bonding layer, it is desirable to use gold (Au), because it is soft and has an excellent bonding property to the base. Consequently, the material for forming the bonding layer is specified to be gold or a gold alloy. In particular, it is desirable that the bonding layer be made of gold having high purity. It is most desirable to use pure gold.

When the bonding layer is formed by using a gold alloy, it is desirable that the alloy contain the gold at least 95 mass percent (the term “mass percent” is used to mean “weight percent” throughout this specification). The alloying element for the gold alloy may be the element that constitutes the base. Even when the bonding layer is formed by using pure gold, the element constituting the base diffuses into the gold that forms the bonding layer to form an alloy in some cases. Therefore, in the present invention, the types of the gold alloy forming the bonding layer include, in addition to the gold alloy into which an alloying element is intentionally added, a gold alloy formed by the diffusion of the element constituting the base.

Gold has a low melting point. Consequently, in consideration of the resistance to the heat generation due to the collision of electrons, gold is not a desirable material for the covering layer. Nevertheless, in the present invention, gold and a gold alloy are not used for a heat-resistant layer. Instead, as described above, they are used for the bonding layer to bond the surface layer made of the first material having a high melting point to the base. Therefore, even when a layer formed by using the foregoing element having a low melting point is provided on the base, an electrode of the present invention can contribute to the realization of a cold-cathode fluorescent lamp having high brightness and long life.

The bonding layer can be formed by the electroplating method or the vacuum deposition method. In particular, as described above, the electroplating method can form a uniform bonding layer and has an excellent mass-productivity. Therefore, it is desirable to use this method.

The bonding layer is required only to have a thickness to such an extent that it can sufficiently bond the surface layer to the base. If the bonding layer is excessively thin, the surface layer tends to separate from the base easily. If excessively thick, destruction occurs at the interior of the bonding layer (gold), increasing the tendency of separation. More specifically, the bonding layer is specified to have a thickness of 0.01 to 1 μm, desirably 0.03 to 0.10 μm.

The base can be formed, for example, by using a conventional electrode material, such as nickel (Ni), tungsten (W), or molybdenum (Mo). Pure Ni is excellent in processability and cost efficiency. W and Mo have a melting point extremely higher than that of pure Ni. Therefore, even when the covering layer disappears, they can suppress the consumption of the electrode and the reduction in brightness.

In addition, as the material for forming the base, an Ni alloy produced by adding an alloying element to pure Ni may be used. More specifically, the Ni alloy may contain at least one element selected from the group consisting of Ti, Hf, Zr, V, Fe, Nb, Mo, Mn, W, Sr, Ba, B, Th, Be, Si, Al, Y, and rare-earth elements (except Y) with a total amount of at least 0.001 mass percent and at most 5.0 mass percent, with the remainder being composed of Ni and impurities. Alternatively, the Ni alloy may contain at least one element selected from the group consisting of Be, Si, Al, Y, and rare-earth elements (except Y) (these elements are included in the foregoing group of elements) with a total amount of at least 0.001 mass percent and at most 3.0 mass percent, with the remainder being composed of Ni and impurities. In particular, it is desirable to use an Ni alloy containing Y, because the alloy can increase the sputtering resistance.

The above-described Ni alloy has various advantages as shown below:
(a) it has a work function smaller than that of pure Ni, thereby facilitating the discharging,
(b) it is resistant to sputtering (a sputtering rate or etching rate is small),
(c) it is resistant to forming an amalgam, and
(d) it is resistant to forming an oxide film, so that the discharging is impervious to being impeded.
   Therefore, in the case of an electrode having a covering layer on the base made of the foregoing Ni alloy, even when the covering layer is consumed and consequently the base is exposed, the electrode can suppress the reduction in brightness and the consumption of the electrode. The work function and etching rate can be varied by changing the types of the alloying element in the Ni alloy and controlling the content of the alloying element.

In addition, as the material for forming the base, iron (Fe) or an iron alloy (an Fe alloy) may be used. As described above, of the lead wires that supply electric power to the electrode, the inner lead wire is fixed in the glass tube. The inner lead wire is usually formed by using a material having a coefficient of thermal expansion close to that of the glass. As the material satisfying this requirement, an iron-nickel-cobalt alloy is used that is formed by adding cobalt (Co) and nickel (Ni) to iron. As the iron-nickel-cobalt alloy, there is an alloy known as Kovar, for example. In addition to the foregoing material, as the material for forming the inner lead wire, an iron-nickel alloy and an iron-nickel-chromium alloy may also be used. These iron alloys are excellent in plastic processability and cutting processability. Consequently, when the inner lead wire and the electrode are formed as a unitary body by using the foregoing iron alloy, the producibility can be improved because it is not necessary to produce the two members separately and to bond them by welding or another method. On the other hand, iron is superior to tungsten and molybdenum in plastic processability. In addition, iron has a melting point close to that of the above-described iron alloy to be used as the material for forming the inner lead wire. Consequently, the base made of iron can be bonded to the inner lead wire by welding easily and reliably. Iron and an iron alloy are relatively low-cost and therefore excellent in cost efficiency. Furthermore, iron and an iron alloy have a low work function. The above-described facts render iron and an iron alloy desirable material for forming the base. Nevertheless, although an electrode formed by using iron or an iron alloy has a low work function, the electrode speedily reacts with the mercury in the glass tube, so that it is anticipated that the electron-emitting property will be deteriorated. Therefore, it is considered that when an electrode is formed by using iron or an iron alloy, the electrode has difficulty in sufficiently having the property required for the electrode. On the other hand, although the metal that forms the foregoing covering layer, such as rhodium or palladium, has a work function slightly larger than that of iron and an iron alloy, the metal is excellent in electron-emitting property because it has a large number of existing surface atoms that considerably contribute to the emission of electrons. Consequently, when the above-described covering layer is provided on the base made of iron or iron alloy, the electron-emitting property can be improved. Such an electrode is likely to contribute to the increase in the brightness and life of the fluorescent lamp.

The types of iron and iron alloy include (a) the so-called pure iron that contains at most 0.1 mass percent carbon (C) and at least 99.9 mass percent Fe with the remainder being composed of impurities and (b) steel. It is not desirable to use steel containing more than 0.1 mass percent carbon because it has high hardness and generates flaws and surface unevenness at the time of machining, thereby adversely affecting the surface properties. As an iron alloy other than steel, it is desirable to use an alloy that has a coefficient of thermal expansion close to that of the glass, as described above. The types of such an alloy include an Ni-containing alloy, namely, an iron-nickel alloy. The types also include a cobalt-added iron-nickel alloy, which is an iron-nickel-cobalt alloy, and a chromium-added iron-nickel alloy, which is an iron-nickel-chromium alloy. The specific compositions of these iron alloys are shown below.
(a) An iron-nickel alloy: the alloy contains 41 to 52 mass percent Ni with the remainder being composed of Fe and impurities.
   This alloy may further contain at most 0.8 mass percent Mn and at most 0.3 mass percent Si.
(b) An iron-nickel-cobalt alloy: the alloy contains 28 to 30 mass percent Ni and 16 to 20 mass percent Co with the remainder being composed of Fe and impurities.
   This alloy may further contain 0.1 to 0.5 mass percent Mn and 0.1 to 0.3 mass percent Si. In addition, as this alloy, commercially available Kovar may be used.
(c) An iron-nickel-chromium alloy: the alloy contains 41 to 46 mass percent Ni and 5 to 6 mass percent Cr with the remainder being composed of Fe and impurities.
   This alloy may further contain at most 0.25 mass percent Mn.

An electrode of the present invention can be used in various shapes. Typical examples include the shape of a cup, which is a hollow tube having a bottom, and the shape of a solid column. The cup-shaped electrode is desirable because it can suppress the sputtering to a certain extent on account of the hollow-cathode effect. The columnar electrode can be formed by cutting, in a specified length, a wire-shaped material made of the first material or the material for forming the base. Therefore, its production is easy. The cup-shaped electrode can be formed, for a typical example, by pressing a plate-shaped material made of the first material or the material for forming the base. When the main body of the electrode made of the base-forming material (the body before the covering layer is formed) and the inner lead wire are formed as a unitary body, first, a wire-shaped material made of the base-forming material is produced. Then, a forging operation is performed at one end of the wire-shaped material. Thus, the main body of the cup-shaped electrode can be formed. The other end of the wire-shaped material may be processed by cutting as required to adjust the diameter of the inner lead wire. Alternatively, the entire wire-shaped material made of the above-described base-forming material may be processed by cutting to unitarily form the cup-shaped main body of the electrode and the wire-shaped inner lead wire. When a solid columnar main body of the electrode and a wire-shaped inner lead wire are unitarily formed, one end of the above-described wire-shaped material may be used as the main body of the electrode and the other end may be used as the inner lead wire. The other end of the wire-shaped material may be processed by cutting as required to adjust the diameter of the inner lead wire. An electrode of the present invention is intended to include a structure in which the main body of the electrode and the inner lead wire are unitarily formed.

In the case where an electrode of the present invention is structured with a base (the main body of the electrode) and a covering layer, when the base has the shape of a cup, it is desirable that the covering layer be formed so as to cover at least the entire inner surface of the cup, more specifically, the entire surface of both the inner circumferential surface of the tubular portion of the cup and the inner surface of the bottom portion. Of course, the covering layer may be formed so as to cover the entire surface of both the inner surface and the outer surface of the cup. When the covering layer is provided partially, it is recommended that the covering layer be formed by taking a measure to make sure that the portion not to be provided with the covering layer is not provided with it. For example, when the covering layer is formed through the plating method, the following measures may be taken: (a) the base is partially masked or (b) a sacrificial electrode or shielding plate is placed in the vicinity of the portion not to be provided with the covering layer in the base. When the covering layer is formed through the sputtering method or vacuum deposition method, a shielding plate may be used that controls the diffusion area of the particles that form the covering layer. When the electrode is produced by unitarily forming the inner lead wire and the main body of the electrode, the surface of the inner lead wire is provided with the foregoing masking to prevent the formation of the covering layer.

An electrode of the present invention is used as the electrode for a cold-cathode fluorescent lamp. The cold-cathode fluorescent lamp is provided with a glass tube that has a layer of a fluorescent substance on its inner surface, that has sealed-in rare gas, such as argon or xenon, and mercury, and that has an electrode of the present invention in it.

### EFFECT OF THE INVENTION

An electrode of the present invention is structured such that at least one part of the electrode's surface is formed by using a material that is resistant to alloying with mercury and that has a high melting point. Consequently, when the electrode is used as the electrode of a cold-cathode fluorescent lamp, the lamp can not only suppress the reduction in the brightness due to the consumption of the mercury or insufficient discharging but also reduce the consumption of the mercury and electrode. As a result, a cold-cathode fluorescent lamp of the present invention provided with an electrode of the present invention has high brightness and long life.

### BEST MODE FOR CARRYING OUT THE INVENTION

Embodiments of the present invention are explained below.

Materials for forming bases having compositions shown in Table 1 were used to produce cup-shaped electrodes and circular-column-shaped electrodes, each having an outer diameter of 1.6 mm and a length of 3.0 mm. Cold-cathode fluorescent lamps incorporating the electrode were produced to evaluate their brightness and life.

The cup-shaped electrodes were produced by the procedure shown below the ingot made of the material for forming the base having the composition shown in Table 1 was processed by hot rolling. The obtained rolled plate was subjected to a heat treatment and a subsequent surface cutting process. The surface-treated material underwent repeated cold-rolling operations and heat treatments. Then, the final heat treatment (the softening treatment) was performed on the material to produce a plate-shaped material having a thickness of 0.1 mm. The plate-shaped material was cut to a specified size. The obtained piece of plate was subjected to a cold-pressing process to produce a cup-shaped base. The as-produced base was used as a cup-shaped electrode having no covering layer. On the other hand, a cup-shaped electrode having a covering layer was provided on the produced base with a bonding layer and a surface layer each having a composition as shown in Table 1 through the electroplating method. The thickness of the covering layer was varied by adjusting the plating time. The covering layer was provided on the entire surface of the electrode (the entire inner surface and entire outer surface of the electrode).

The circular-column-shaped electrodes were produced by the procedure shown below the ingot made of the material for forming the base having the composition shown in Table 1 was processed by hot rolling. The obtained rolled wire rod was subjected to a combination of a cold drawing process and a heat treatment. Then, the final heat treatment (the softening treatment) was performed on the wire rod to produce a wire-shaped material having a diameter of 1.6 mm. The wire-shaped material was cut to a specified length (3 mm) to produce a circular-column-shaped base. The as-produced base was used as a circular-column-shaped electrode having no covering layer. On the other hand, a circular-column-shaped electrode having a covering layer was provided on the produced base with a bonding layer and a surface layer each having a composition as shown in Table 1 through the electroplating method. The thickness of the covering layer was adjusted by the plating time. The covering layer was provided on the entire surface of the electrode.

After the covering layer was formed, the bonding condition of the surface layer was examined. The examination revealed that in every electrode, there was no separation of the bonding layer from the base, showing a sufficient bonding. In addition, after the covering layer was formed, the composition of the bonding layer was also examined. According to the examination, some alloys (an Au—Ni alloy and an Au—Fe alloy) were recognized. The Ni and Fe are likely to have diffused from the base. Even when the bonding layer was alloyed, the bonding property showed no problem.

TABLE 1
Structure of electrode

| | Covering layer | | | | | |
|---|---|---|---|---|---|---|
| | Surface layer | | Bonding layer | | | |
| Elec- | | Thick- | | Thick- | | |
| trode | | ness | Ele- | ness | Base | |
| No. | Element | (μm) | ment | (μm) | Element | Shape |
| 1 | — | | | | Ni | Cup |
| 2 | Rh | 0.05 | Au | 0.05 | Ni | |
| 3 | Rh | 0.5 | Au | 0.05 | Ni | |
| 4 | Rh | 5 | Au | 0.05 | Ni | |
| 5 | Rh | 0.5 | Au | 0.01 | Ni | |
| 6 | — | | | | Rh | |
| 7 | Rh | 0.5 | Au | 0.01 | Ni— | |
| | | | | | 0.35 | |
| | | | | | mass % Y | |
| 8 | — | | | | Ni | Circular |
| 9 | Rh | 0.5 | Au | 0.01 | Ni | column |
| 10 | 85 mass % Pd— | 0.05 | Au | 0.05 | Ni | Cup |
| | 15 mass % Co | | | | | |
| 11 | 85 mass % Pd— | 0.5 | Au | 0.05 | Ni | |
| | 15 mass % Co | | | | | |
| 12 | 85 mass % Pd— | 5 | Au | 0.05 | Ni | |
| | 15 mass % Co | | | | | |
| 13 | Pd | 0.5 | Au | 0.05 | Ni | |
| 14 | Rh— | 0.5 | Au | 0.05 | Ni | |
| | 20 mass % Pd | | | | | |
| 15 | Rh— | 0.5 | Au | 0.05 | Ni | |
| | 5 mass % Co | | | | | |
| 16 | Rh | 0.5 | Au | 0.05 | Fe— | |
| | | | | | 0.025 | |
| | | | | | mass % C | |
| 17 | Rh | 0.5 | Au | 0.05 | Fe— | |
| | | | | | 42 mass | |
| | | | | | % Ni | |
| 18 | Rh | 0.5 | Au | 0.05 | Fe— | |
| | | | | | 30 mass | |
| | | | | | % Ni— | |
| | | | | | 16 mass | |
| | | | | | % Co | |

A cold-cathode fluorescent lamp was produced by the procedure shown below. An inner lead wire made of Kovar was welded with an outer lead wire made of copper-coated Ni-alloy wire. The inner lead wire was bonded by welding to the bottom face or end face of an electrode produced as described above. An electrode (base) made of nickel, nickel alloy, iron, or iron alloy and an inner lead wire made of Kovar have a melting point comparable or relatively close to each other. Consequently, they can be easily bonded to each other by welding. A glass bead was attached by fusion to the inner lead wire so as to enclose the entire outer circumference of it. This operation produced an electrode member in which the lead wires, electrode, and glass bead were consolidated into one unit. Two of the above-described electrode members were prepared. The base may be provided with the covering layer under the condition that both lead wires and the glass bead are attached to the base.

When an iron-nickel alloy or an iron-nickel-cobalt alloy is used as the material for forming the base, the base and inner lead wire may be formed unitarily. The procedure for producing the unitary body is shown below. First, a wire-shaped material is produced as in the case where the above-described circular-column-shaped electrode is produced. The wire-shaped material is cut to a specified length (4 mm). One end portion (the portion from the end face to a position longitudinally 1 mm away from the end face) of the obtained short material is subjected to a cold-forging process to produce a cup-shaped electrode. The other end portion undergoes a cutting process as required to produce a wire-shaped inner lead wire. An outer lead wire is bonded to the end of the inner lead wire.

On the other hand, a glass tube was prepared that had a fluorescent-substance layer (in this evaluation test, halophosphate fluorescent-substance layer) on its inner surface and that had an open end at both sides. One electrode member was inserted into one end of the open-end tube. The glass bead and the end portion of the tube were fusion-bonded to each other, so that the end of the tube was sealed and the electrode member was fixed in the tube. Next, the glass tube was vacuum evacuated from the other end, which was still open, to introduce rare gas (in this evaluation test, Ar gas) and mercury. The other electrode member was fixed as with the foregoing electrode member and the glass tube was sealed. Through this procedure, in the case of the cup-shaped electrode, a cold-cathode fluorescent lamp (a sample) was obtained in which a pair of the opening portions of the electrodes were placed so as to face each other. In the case of the circular-column-shaped electrode, a cold-cathode fluorescent lamp (a sample) was obtained in which a pair of the end faces of the electrodes were placed so as to face each other.

The brightness and life of the produced individual samples are evaluated in the following way. The center brightness (43,000 cd/m²) and life of Sample No. 1 provided with Electrode No. 1 (a cup-shaped electrode made of Ni) are defined as 100 to use as the reference. The brightness and life of the individual samples provided with other electrodes are expressed in relation to the reference for the evaluation. The evaluation results are shown in Table 2. The life is defined as the period when the center brightness has decreased to 50 percent.

TABLE 2

| Sample No. | Brightness | Life |
|---|---|---|
| 1 | 100 | 100 |
| 2 | 300 | 110 |
| 3 | 310 | 120 |
| 4 | 320 | 210 |
| 5 | 310 | 120 |
| 6 | 320 | 400 |
| 7 | 310 | 395 |
| 8 | 80 | 40 |
| 9 | 240 | 60 |
| 10 | 220 | 105 |
| 11 | 230 | 110 |
| 12 | 240 | 185 |
| 13 | 230 | 115 |
| 14 | 280 | 115 |
| 15 | 290 | 110 |
| 16 | 310 | 120 |
| 17 | 320 | 110 |
| 18 | 310 | 110 |

As shown in Table 2, the sample provided with an electrode either having a base made of rhodium or having a covering layer made of rhodium or palladium has a higher brightness and a longer life than those of the sample provided with an electrode both having a base made of a metal other than rhodium and having no covering layer. In particular, as the thickness of the surface layer of the electrode of a sample increases, the sample increases its brightness and life. According to these results, it is likely that the electrode having a surface formed of a material selected from rhodium, palladium, and alloys of these contribute to the realization of a cold-cathode fluorescent lamp having high brightness and long life.

In addition, the sample provided with a cup-shaped electrode has a higher brightness and a longer life than those of the sample provided with a circular-column-shaped electrode. Furthermore, the sample provided with an electrode having a covering layer made of rhodium has a higher brightness and a longer life than those of the sample provided with an electrode having a covering layer made of palladium. The sample provided with an electrode having a base made of Ni alloy has a longer life than that of the sample provided with an electrode having a base made of Ni. The reason why the sample provided with an electrode having the base made of Ni alloy has increased life can be considered as follows. Because the base made of Ni alloy not only allows the base itself to discharge easily but also has excellent sputtering resistance, even after the covering layer is consumed, the reduction in brightness and the consumption of the electrode can be suppressed. Moreover, the sample provided with an electrode having a base formed of Fe (containing 0.025 mass percent C) or Fe alloy has high brightness and long life. This is attributable to the fact that the covering layer has an excellent electron-emitting property.

The above-described embodiments can be modified as required without deviating from the main point of the present invention and are not limited to the above-described structure. For example, the base of the electrode may be formed by using W or Mo. Furthermore, the use of the glass bead may be eliminated.

The present invention is explained above in detail and by referring to the specific embodiments. It should be obvious to the person skilled in the art that the present invention can be altered or modified in various ways without deviating from the spirit and scope of the present invention. The present application is based on the Japanese patent application (Tokugan 2006-213947) filed on Aug. 4, 2006 and the Japanese patent application (Tokugan 2006-322637) filed on Nov. 29, 2006, and the description of these applications is incorporated herein as reference.

### INDUSTRIAL APPLICABILITY

An electrode of the present invention can be suitably used as the electrode for a cold-cathode fluorescent lamp. A cold-cathode fluorescent lamp of the present invention can be suitably used as the light source of various electric devices, such as a light source as a backlight for a liquid-crystal display, a light source as a frontlight for a small display, a light source for illuminating documents in a copying machine, a scanner, or the like, and a light source for an eraser of a copying machine.

1. An electrode for a cold-cathode fluorescent lamp, wherein at least one part of the electrode surface is formed by using one material selected from a first group consisting of rhodium, palladium, and alloys of these.

2. An electrode for a cold-cathode fluorescent lamp as defined by claim 1, the electrode comprising a base and a covering layer that covers the surface of the base; the covering layer comprising:
(a) a surface layer made of a material selected from the first group; and
(b) a bonding layer that is made of gold or gold alloy and that is placed between the base and the surface layer.

3. An electrode for a cold-cathode fluorescent lamp as defined by claim 1, the electrode having the shape of a cup.

4. An electrode for a cold-cathode fluorescent lamp as defined by claim 2, wherein the base is formed by using one material selected from a second group consisting of nickel, a nickel alloy, iron, an iron alloy, tungsten, and molybdenum.

5. A cold-cathode fluorescent lamp, having an electrode,
wherein at least one part of the electrode surface is formed by using one material selected from the first group consisting of rhodium, palladium, and alloys of these.
